(19) United States
(12) Patent Application Publication
(10) Pub. No.: US 2010/0264094 A1
(43) Pub. Date: Oct. 21, 2010

(54) METHOD OF DEVELOPING A RAPIDLY SETTLING ALGAL FLOC

(75) Inventors: Gregory Schwartz, Indio, CA (US); Michael Massingill, San Diego, CA (US); Jon Van Olst, Bonsall, CA (US); James Carlberg, San Diego, CA (US)

Correspondence Address: RICHARD D. CLARKE;LAW OFFICE OF RICHARD D. CLARKE, 3755 AVOCADO BLVD., #1000, LA MESA, CA, 91941-7301, US

(73) Assignee: KENT BIOENERGY CORPORATION, San Deigo, CA (US)

(21) Appl. No.: 12/756,690

(22) Filed: Apr. 8, 2010

Related U.S. Application Data
(60) Provisional application No. 61/212,753, filed on Apr. 16, 2009.

(51) Int. Cl. C02F 1/24

(52) U.S. Cl. 210/747; 210/776

(57) ABSTRACT

Rapidly settling algal strains are selectively developed through a method that is based on manipulating the velocity of a host liquid. In one embodiment, the method includes the steps of providing a uniform flow velocity to the liquid, thereby promoting development of one or more algal strains; stopping or at least reducing the uniform flow velocity; removing the upper portion of the water, including any suspended algal strains; providing a second uniform flow velocity to the liquid, which may be the same as the flow velocity that was applied during the first step; stopping or at least reducing the second uniform flow velocity; and removing the upper portion of the remaining liquid, leaving a residual liquid amount that includes one or more rapidly settling algal strains in the form of a rapidly settling algal floc or of a precursor thereof.

### FIELD OF THE INVENTION

The present invention relates to a method of growing and harvesting microalgae. More particularly, the present invention relates to a method of developing a rapidly settling algal floc in a liquid container.

### BACKGROUND OF THE INVENTION

Algae have long been recognized as having a number of useful applications. For example, algae are utilized as a base element in the production of cosmetic and food products, as an agent of water purification in wastewater treatment processes, and as a source of oils in the production of biofuels. Various documents in the prior art have described industrial applications based on algal production processes. For example, U.S. Pat. No. 2,867,945 to Gotaas et al. teaches a process of photosynthetic conversion of organic waste by algal-bacterial symbiosis.

Algae are typically grown and harvested in containers such as tanks, ponds, and photobioreactors. Some of the major limitations impacting microalgal cultures relate to the technical complexities and high costs associated with algal harvest and oil extraction. The ability to easily harvest microalgae has been one of the major obstacles preventing a more widespread utilization of algae in applications to achieve wastewater treatment, food ingredients, biofuels, and other commercial products.

A variety of techniques for harvesting of microalgae have been proposed, including centrifugation, filtration, and air floatation techniques, but all have proved difficult and costly. These difficulties have been documented in a number of publications, for example, in Benemann et al., Algae Biomass (C. Soeder and G. Shelef, eds.), Elsevier, pp. 457-496 (1980); Benemann and Oswald, DOE Final Report: Systems and Economic Analysis of Microalgae Ponds for Conversion of CO₂ to Biomass, (1996); Sheehan et al., Close Out Report, Aquatic Species Program, NREL/TP380-24190 (1998): Schwartz, The algae alternative, The Boston Globe (Jul. 12, 2004).

In particular, bio-flocculation has been proposed as a technique for harvesting micro-algae, by which algal cells flocculate spontaneously without the use of chemical flocculating agents. While this process has produced satisfactory results, the exacting requirements of wastewater treatment could not be met due to lack of sufficient reliability. A major reason has been identified as the irreproducible nature of the phenomenon, which does not appear to occur with any regularity. See Benemann and Oswald, supra, at pages 92 and 108.

Therefore, there is a need for a method of developing a rapidly settling algal floc, species, or matrix, such to increase the efficiency of harvesting algae, increase process yields and reduce operating costs.

There is also a need for a method of developing a rapidly settling algal floc, matrix or species that is reliable over time.

### SUMMARY OF THE INVENTION

It is an advantage of the present invention to provide a method that enables the reliable and consistent selection of rapidly settling algal flocs.

It is another advantage of the present invention to increase the efficiency of algal production processes.

It is still another advantage of the present invention to reduce operating costs of algae production and harvesting.

It is yet another advantage of the present invention to identify rapidly settling algal flocs, species, or matrix that may be used to inoculate other algal growth systems.

The present invention achieves these and other advantages by providing a method of selectively developing algal flocs, species, or matrix which settle more rapidly than other algal species. This method is identified herein as Serial Selection for Bioflocculation™ (SSB) and is based on manipulating the velocity of the host liquid and on selectively decanting the host liquid and its algal components. For the sake of simplicity but without limiting intent, exemplary embodiments will be described herein that employ water as a host liquid.

An exemplary method according to the invention includes the steps of providing a uniform flow velocity within a water container, thereby promoting development of one or more algal flocs, species, or matrix; stopping or at least reducing the uniform flow velocity; removing the upper portion of the water from the container, including any suspended algal strains; providing a second uniform flow velocity to the water, which may be the same as the flow velocity that was applied during the first step; stopping or at least reducing the second uniform flow velocity; and removing the upper portion of the remaining liquid in the container, leaving a residual water amount in the container that includes one or more rapidly settling algal strains in the form of the rapidly settling algal floc or of a precursor thereof. Throughout the present description, a “uniform flow velocity” is defined as a flow velocity that is substantially free of stagnant, quiescent zones, or low-velocity dead zones, or of any areas of reduced flow (eddies) that permit algal settling.

The above described process may be carried out in a container configured like a tank, a raceway, a vessel, or a pond, and the uniform water velocities may be provided by a paddlewheel, a pump, an airlift device, or any other suitable water movement system. Preferably, the water container is essentially free of areas that are stagnant or that have reduced or reversed flow areas. This may be achieved by providing one or more flow dividers within the container.

In an embodiment of the invention, the uniform flow velocities are applied for 1-3 days and within a range of 0.25-3 ft/sec (0.08-0.9 m/sec), and may be stopped abruptly for a period of 5-60 minutes to cause algal sedimentation.

The upper portions of the liquid that are removed after water flow has been stopped or at least reduced may correspond to about 50% or more of liquid volume in the container. In an embodiment of the invention, water may be added after the upper portion of the liquid has been removed and before a uniform flow velocity is applied again. The added water may be new input water, or water that had been removed previously, and had been treated to remove or kill any algal strains present therein.

After an algal floc has begun to form, a higher or lower flow velocity may be applied to the water, for example, a velocity of at least 0.5 ft/sec (0.15 m/sec).

In another embodiment of the invention, at least one rapidly settling algal strain is inoculated into the liquid before the first uniform flow velocity is applied to the container. In still another embodiment of the invention, naturally occurring or native strains of algae (which are not necessarily of a rapid settling type) are inoculated into the liquid before the first uniform flow velocity is applied to the container. In yet another embodiment of the invention, algae are allowed to form spontaneously without inoculation.

The above described stop-and-go cycle may be repeated every few days, or until about more than 50% of suspended algae settle within a predetermined amount of time (for example, until 90% of suspended algae settle within 10 minutes), or may be repeated for a predetermined amount of time (for example, for a period of 3-8 weeks), or until an algal floc of desired consistency is achieved. Water velocity is eventually stopped and the algal floc is harvested.

In an embodiment of the invention, the water is transferred into a second container before stopping water velocity and/or before harvesting the algal floc. Harvesting may be performed on a batch or on an essentially continuous basis.

### BRIEF DESCRIPTION OF THE DRAWINGS

The drawings constitute a part of the present specification and depict exemplary embodiments of the invention. It is to be understood that in some instances various aspects of the invention may be shown exaggerated or enlarged to facilitate an understanding of the invention.

FIGS. 1A and 1B are perspective views of an exemplary system for developing a rapidly settling algal floc, species, or matrix. In particular, FIG. 1A depicts a variant where water movement and decanting are performed in separate containers, while FIG. 1B depicts a variant where water movement and decanting is performed in a single container.

FIG. 2 is a first chart depicting algal settling rates obtained by implementing a method according to the invention.

FIG. 3 is a second chart depicting algal settling rates obtained by implementing a method according to the invention.

FIG. 4 is a chart depicting settling rates in a larger algal growth unit than the units of FIGS. 2 and 3, obtained by implementing a method according to the invention.

FIG. 5 depicts a graduated cylinder having evenly spaced petcock valves and useful for testing algal settling rates.

FIG. 6 is a chart depicting settling rates in a 35 square meter algal pond over different periods of time using a method according to the invention.

### DETAILED DESCRIPTION OF EMBODIMENTS OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

In one aspect, the present invention relates to a method of developing a rapidly settling algal floc or matrix that is based on the discovery of a basic principle, that the establishment of a rapidly settling algal floc is greatly enhanced when predetermined changes in velocity are applied to the liquid where the algal floc is to be developed, particularly when combined with the subsequent selective separation of non-settling algae from the developing settling algal floc, strains, or matrix. Such method is identified herein as Serial Selection for Bioflocculation™ (SSB).

An exemplary method according to the invention includes the step of maintaining the liquid at a uniform velocity for a predetermined amount of time, followed by the step of providing a period of rest or at least of reduced velocity, during which a portion of the liquid is removed, including all the algae suspended therein. One or more periods of uniform velocity and of rest with liquid removal are applied again until an algal biomass with the desired settling rated is achieved.

A detailed description of exemplary methods and systems according to the invention follows, together with data illustrating the improvements over the prior art that have achieved through the practice of the invention.

In a first exemplary method, a liquid suitable for the growth of algae is collected in a container, for example, in a tank, raceway, vessel or pond. Such liquid may be water or a liquid that contains algal nutrients, for example, a leachate or other wastewater that is rich in nitrogen and phosphorus, as well as other contaminants, the removal of which by the action of the algae purifies the liquid. For the sake of simplicity, the following description will be based on using water as a liquid medium.

A uniform flow velocity is applied to the water while at the same time insuring that stagnant areas, quiescent zones, low-velocity dead zones, or areas of reduced or reversed flow (eddies) that permit algal settling are avoided. Any such areas could result in failure to achieve an efficient SSB, because the settling algae would concentrate in the dead zones and hinder the selective pressure to accumulate fast-settling algae within a continuous culture. In fact, stagnant areas may cause the death of the algae in those areas, reducing process yields.

Throughout the present description, the term “uniform flow velocity” is defined as a flow velocity that is substantially free of stagnant areas, quiescent zones, low-velocity dead zones, or any areas of reduced flow (eddies) that permit algal settling. Moreover, the term “algal floc” is understood also to include “algal matrix.”

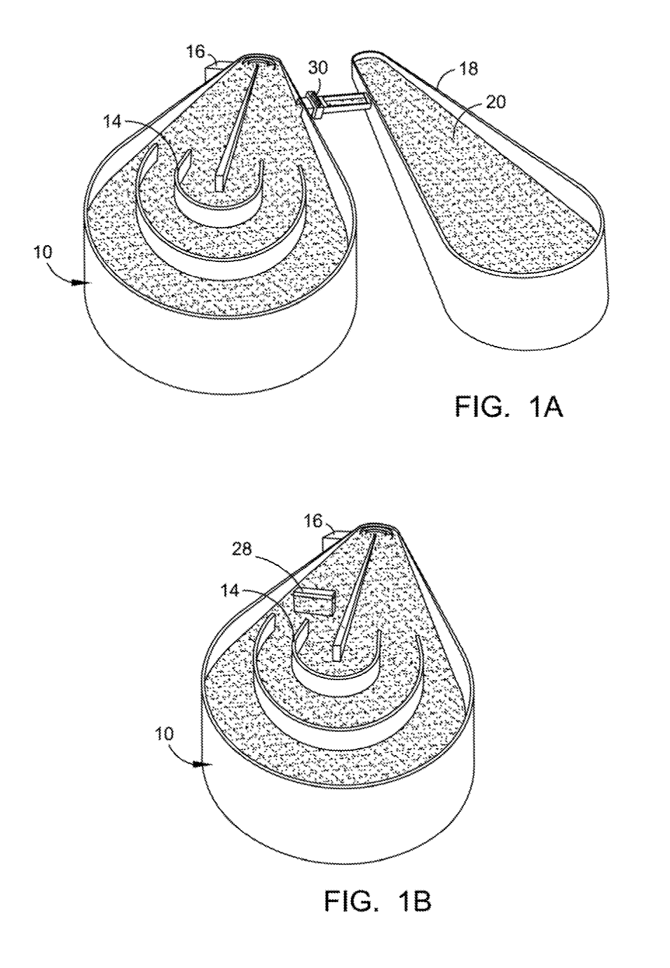

FIGS. 1A and 1B each illustrate a container 10 configured to provide uniform liquid flow. Water is circulated longitudinally in opposite directions defined by central divider 12. Flow dividers 14 are provided in areas that are particularly prone to forming areas of non-uniform flow, as in the end portions of container 10 in the illustrated example. The arrangement of flow dividers 14 shown in FIG. 1 is only exemplary and a person skilled in the art will recognize that the number and relative positions of flow dividers 14 will vary according to the shape and size of container 10, and to the devices used to impart velocity to the water.

Algae may become established in container 10 by spontaneous growth of naturally occurring native strains (a passive algal establishment process) or by inoculation of either naturally occurring strains, typically non-settling, or of one or more rapidly settling algal strains (an active algal establishment process). The inoculated algae may be harvested from another algal culture where the rapidly settling algal strains have previously become established, as explained in greater detail below.

The uniform water velocity may be provided by a pump 16, a paddlewheel, an airlift device, or a combination thereof, or through other devices known to a person skilled in the art. For proper establishment and maintenance of fully developed SSB algal flocs, these water-moving devices must operate without shearing, damaging or destroying the flocs.

As mentioned, maintaining a uniform water-velocity is very important. In one experiment, an effort was made to initiate SSB by seeding in a 0.7 acre (2832 square meter) pond, but the presence of highly variable velocity zones resulted in failure. The SSB type algal matrix settled out in the low velocity zone and the desired SSB was not achieved.

One of the benefits of continuous water circulation is believed to rest in the water mixing effect, which increases the effective penetrative depth of solar radiation, allowing for increased biomass production per unit area.

The desired horizontal water velocity typically ranges between 0.05 to 2.0 ft/sec (0.015-0.06 m/s), preferably between 0.1 and 0.5 ft/sec (0.03-0.15 m/sec). In typical algal production units, increased water velocity results in increased costs, so lower horizontal water velocities will result in lower costs, provided that biomass production is not affected to a significant degree.

After the uniform flow velocity has been applied for a predetermined amount of time (for example, for two days), water velocity is greatly reduced, preferably stopped entirely. This allows algal settling to occur, thereby separating the algae from the water column. This temporary stoppage/reduction of water circulation can occur within container 10, as shown in FIG. 1B, and may be achieved by stopping or reducing the uniform flow velocity in the entire container 10, or by allowing water to settle within a box portion 26 while the water continues to circulate in the remainder of container 10.

Alternatively, the temporary stoppage/reduction of water circulation may occur in an external tank or container 18 where the algal water is diverted, as shown in FIG. 1A. Water diversion may be continuous or intermittent through the use of a gate 30 or other similar device.

In either case, the stop of the water flow may be abrupt, to increase the rate of settlement of the algal strains.

The water then remains in a quiescent settling period, typically of 5 to 60 minutes, preferably 15-30 minutes, such to enable the algae suspended in the water to settle. At the end of the quiescent settling period, a portion of the water in the upper part of container 10 or 18 is removed (for example, the upper portion of water 20 in container 18), which includes all the algal strains suspended in that portion of the water. Such removal causes the removal of the slower settling algal strains, which are still in suspension, while the faster settling algal strains have amassed in the lower portion of the container.

In an embodiment of the invention, 50% or more of the water is removed from the container and is discarded. The decanted water may be used for agricultural irrigation or for other applications.

In another embodiment of the invention, the decanted water is treated to remove and/or kill the suspended algae and is then returned back to the system. While water recycling increases water conservation, few or none of the non-settling algae should be returned back to the system, or the selection and maintenance of fast settling SSB algae or algal complex may be compromised or not occur at all.

After the quiescent period, uniform velocity is imparted again to the remaining water for a predetermined period of time, for example, two days, with a speed preferably again in the range of 0.25-3 ft/sec (0.08-0.9 m/sec). At the end of this period, water velocity is reduced or stopped again, for example, for a period of 5-60 minutes, preferably 15-30 minutes, to cause a new settling of the algal strains contained therein. Once more, the rapidly settling algal strains will concentrate in the lower portion of container 10 (of container 18 if the water is diverted to container 18), while the slower settling algal strains will remain suspended in the upper portion of container 10 or 18. The upper portion of the water in container 10 or 18 is then removed (for example, 50% of the water is removed), which includes all the slower settling algal strains contained therein.

Alternating periods of uniform flow velocity with quiescent periods, during which the slower settling algal strains are removed, causes a selection of the algal strains such that only the fastest settling algal strains remain in the water. This cycle is repeated until the SSB algal floc (sometimes identified as algal matrix or biofloc) is fully developed and fast settling rates have been achieved.

In different embodiments of the invention, the process may be continued for a predetermined period of time, for example, 3-8 weeks, to meet operating schedules; or may be continued until a predetermined rate of settlement is achieved, for example, until 90% of all solids within the water settle within 10 minutes. In other embodiments of the invention, the two approaches may be combined, for example, the steps of providing a uniform flow velocity and of reducing or stopping water flow may be repeated together every 1-3 weeks until a desired rate of solid settlement is achieved. During the entire SSB process, it is important that the hydraulic retention time (HRT) is shorter than the algal retention time (ART), and the settling and decanting process creates this effect.

As mentioned, the algal development process may be started passively, utilizing the spontaneous formation of algae in a liquid exposed to the outer environment, or actively, inoculating one or more rapidly settling algal strains into container 10, or even by inoculating algal strains regardless of their settling ability. For inoculation purposes, algal strains extracted from a different SSB container may be employed, to insure that only or prevalently rapidly settling algal strains are added to the system. Inoculation greatly reduces the time required to develop new SSD production units or systems. For example, the SSB process may last 3-8 weeks if started with a passive approach but only 1-3 weeks if started with an active approach. It should be noted that actual times may vary according to the size and configuration of the algal production systems, of climatic conditions, and of other factors that will be recognized by a person skilled in the art.

Also as mentioned, in an embodiment of the invention, water that has been decanted from the upper portion of container 10 after the uniform flow velocity has been reduced or stopped is not discarded, but instead is recycled back into container 10 after all the suspended algae have been removed, killed, or anyway rendered incapable of reproducing. In another embodiment of the invention, the water decanted from container 10 or 18 may be replaced with new input water (for example, fresh water) that is essentially algae-free.

Once a fast settling algal complex (or floc) has fully developed with SSB in container 10, it can sustain its fast settling characteristics for an extended period of time, even though the specific algal species within the SSB complex may evolve or change.

In addition, after the desired algal floc has become established, algal growth may be continued by maintaining or altering water velocity, for example, by reducing or maintaining water velocities to at least 0.5 ft/sec (0.15 m/sec), which is about double the speed of normal operating conditions. Velocities must impart only energy to the water column to keep the now fully-developed rapid-settling algae suspended in the water column until that time when they are purposefully allowed to enter a quiescent zone where spontaneous settling and efficient algal harvesting can then occur.

In one experiment, SSB was tested in two ponds located in Southern California. Those ponds are normally used for water purification though extraction of dissolved substances in wastewater performed by the algae. Each of those units was 80 square feet (7.5 square meters) large. After several sequential selections, a population of microalgae and plankton developed, which settled extremely rapidly after the circulating and mixing effect of paddlewheels was removed.

Interestingly, the maximum productivity of the SSB algal matrix did not differ significantly from productivity of non-SSB algal species. In addition, a settling of 90% of the solids contained in the two ponds was achieved within 10 minutes just by removing the mixing current produced by the paddlewheels. In particular, the algae quickly settled to the bottom of the unit and clear water could be removed off the top. The settling rate of the algae was measured using Secchi disks and also by measurement of algal build-up at the bottom of graduated glass containers. After the algae had settled, they could be harvested from the bottom of the pond.

In an alternative construction, algae might be harvested on a continuing basis through a side stream harvest. Such side stream process is based on moving algal water from the pond into an external “settling” tank, where settled algae are removed from the bottom using a belt, a conical collection system, or other collection technique. The clean water is decanted off the top of the system as final treated effluent, or returned back to the algal culture pond, or system.

When operating an algal production unit constructed according to the principles of the invention, it is important to frequently monitor the ability of the culture to settle. If non-settling strains of algae begin to dominate the water column, the initial process steps may need to be reapplied. In addition, the amount of harvested SSB algae may be reduced to allow a reestablishing of the SSB algal type.

In the course of the above described experiments, the primary algal species that had developed in the algal ponds were examined microscopically and identified to genus. Microscopic observations confirmed that the SSB process promotes the growth of a rapidly settling community of organisms that develop into a floc when in a quiescent state.

In particular, the algal matrix produced using SSB was often found to contain four or more algal species along with zooplankton and/or bacterial communities. While seasonal variations in species were also observed, one species appeared to remain constant in the California units, a long segmented strand similar to a Ulothrix species. In another SSB culture vessels located in Virginia, this long stranded filamentous type was not observed.

During a springtime experiment run in four units, the rapidly-settling algal mixture consisted primarily of Pediastrum and Scenedesmus. As temperatures increased, three of the four units shifted to a centric diatom, which settled even more rapidly than the Pediastrum-Scenedesmus mixture. A fourth unit maintained three co-dominant species, Pediastrum, Scenedesmus, and a centric diatom. The rates of spontaneous settling in those units during a quiescent period are summarized in Table I, below (VSS=Volatile Suspended Solids):

TABLE I

| | | | | Percent |
|---|---|---|---|---|
| Algal | | Algal VSS | Algal VSS | Reduction |
| Unit | Algal Species | Pre-Settling | Post-Settling | (%) |
| 1 | Pediastrum, | 185 mg/L | 37 mg/L | 80 |
| | Scenedemus | | | |
| 2 | Centric Diatom | 166 mg/L | 11 mg/L | 93 |
| 3 | Centric Diatom | 105 mg/L | 7 mg/L | 93 |
| 4 | Centric Diatom | 107 mg/L | 10 mg/L | 91 |

The shift from Pediastrum and Scenedesmus to a centric diatom during the warming springtime temperatures was expected, but it was encouraging to observe that the algal settling rates did not decrease with the establishment of a new dominant species, but in fact increased. As shown, the three ponds dominated by centric diatoms routinely showed settling rates of 93% or above.

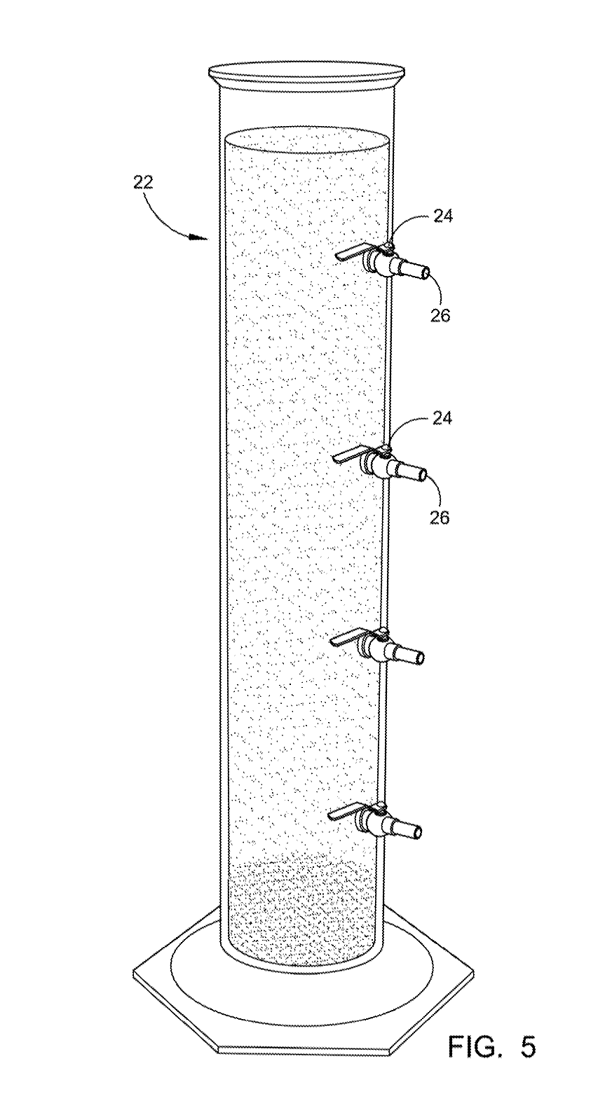

In this experiment, settling was measured using two methods: in-situ Secchi disk monitoring and with algal water sub-samples measured for algal settling rates with the use of a modified graduated cylinder of 2.0 liter capacity like cylinder 22 shown in FIG. 5. In particular, cylinder 22 was modified by installing four petcock discharge valves 24 vertically at 10 cm intervals on the cylinder. The discharge ports 26 allowed for VSS samples to be taken along the entire cylinder depth profile without significantly disturbing the settling algal cells.

In-situ testing was measured during the 30 to 60 minute settling period before decanting. The change in volatile suspended solids concentration (VSS) was measured in all samples. After four weeks of sequential serial dilutions, algal strains were present with settling rates that were 80% or greater than controls.

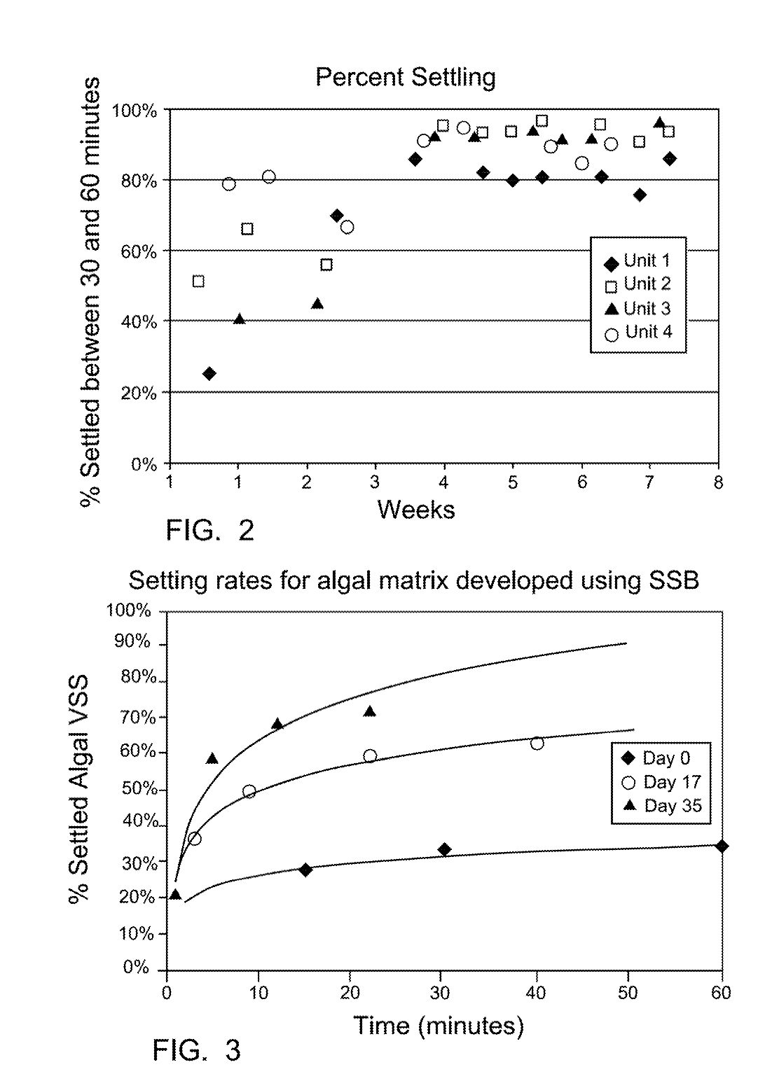

FIG. 2 charts the improved settling rates that occurred over time in two 7.5 square meter algal growth units managed using the SSB approach. That involved sequential water exchanges, settling periods of 30-60 minutes, and decanting of the non-settling strains.

FIG. 3 instead illustrates the settling rates for algal matrix that developed in the same algal growth units as a result of SSD over a period of five weeks. In this experiment, settling rates were also measured either through in-situ sampling using Secchi disks and Erlenmeyer flasks, and through the use of graduated cylinders 22 of 2.0 liter capacity.

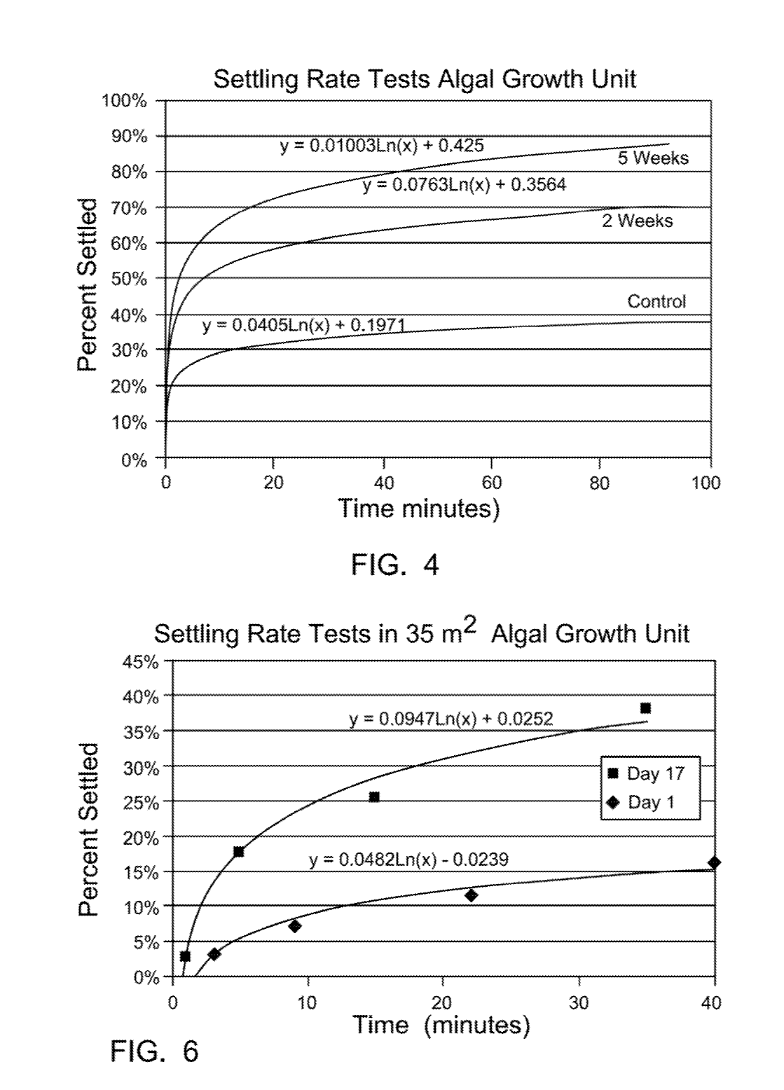

FIG. 4 charts the observed results of microalgae settling rates. In particular, FIG. 4 shows the increase in the settling rate of microalgae cultured in algal growth units after treatment with the SSB approach for two weeks and five weeks. The control curve indicates the settling rate of the same microalgal population prior to initiation of SSB treatment.

These data indicate that after employing the SSB approach for five weeks, more than 80% of the algal species that were present settled for a distance of 30 cm during a period of approximately 40 minutes. Control groups not receiving SSB showed only 35% settling during the same period. Therefore, this experiment provides additional evidence that spontaneous bioflocculation may be induced in microalgal populations that have been grown under conditions of high water velocity and selected for their settling ability over several sequential settling and decanting cycles.

An experiment was also performed to determine whether it would be possible to transfer the strains of algae selected through SSB into larger algal growth units and still maintain their propensity for rapid settling. A larger unit of 35 square meters (375 square feet) was used for this purpose.

Daily transfers of approximately 2 to 4% of the system volume were made from a smaller unit to a larger one, which was operated at a hydraulic retention time of four days. As shown in FIG. 6, excellent results were obtained even within a short period of time (17 days). Settling rates more than doubled in the 35 square meter unit, from 15% settled in 40 minutes to 40% settled in 40 minutes. Mechanical failure prevented the experiment from continuing for more than 17 days, but the results of this study appeared to confirm that it is possible to transfer selected microalgae strains from smaller systems into larger systems and still achieve rapid settling.

The algae may be harvested using a variety of methods. The development of increasingly efficient harvesting methods and systems at lower costs continues to be investigated. Table II summarizes a few of the methods of harvesting microalgae that have been proposed and an assessment of their present operational costs.

TABLE II

| Algae Harvest Method | Relative Cost |
|---|---|
| Foam Fractionation | Very High |
| Ozone Flocculation | Very High |
| Centrifugation | Very High |
| Electrofloatation | High |
| Inorganic Chemical Flocculation | High |
| Polyelectrolyte Flocculation | High |
| Filtration | High |
| Microstraining | High |
| Tube Settling | High |
| Discrete Sedimentation | Medium |
| Phototactic Autoconcentration | Unknown |
| Autoflocculation | Low |
| Bioflocculation | Low |
| Tilapia-Enhanced Sedimentation | Very Low |

An important application of algal ponds is water purification. In one water purification application, leachate produced by landfills or other municipal/industrial wastewater is conveyed to one or more algal production ponds or reactors, where the algae purify the water by removing nutrients such as nitrogen and phosphorus, as well as other contaminants from the leachate or wastewater. It is expected that the present invention will greatly contribute to the development and implementation of efficient water purification plant.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

What is claimed is:

1. A method of developing a rapidly settling algal floc in a liquid comprising the steps of:
providing a first uniform flow velocity within a container of said liquid, thereby promoting formation of one or more algal strains in said liquid;
stopping or reducing said first uniform flow velocity;
removing a first upper portion of said liquid, said first upper portion comprising any algal strains suspended therein;
providing a second uniform flow velocity to said liquid within said container of said liquid;
stopping or reducing said second uniform flow velocity; and
removing a second upper portion of said liquid, a second lower portion of said liquid comprising one or more rapidly settling algal strains that form said rapidly settling algal floc or a precursor thereof.

2. The method of claim 1, wherein said liquid comprises water, wherein said container is a tank, a raceway, a vessel, or a pond, and wherein said first and said second uniform flow velocities are provided by one or more of a paddlewheel, a pump, an airlift device, or other suitable water mixing device.

3. The method of claim 1, wherein the steps of stopping or reducing said first and said second uniform flow velocities and removing said first and said second upper portions of said liquid are performed in a second container of said liquid.

4. The method of claim 1, wherein the step of providing said first and said second uniform flow velocities comprises providing one or more flow dividers within said container.

5. The method of claim 1, wherein said first and said second uniform flow velocities are each comprised within a range of 0.05-3 ft/sec (0.015-0.9 m/sec).

6. The method of claim 1, wherein the step of stopping or reducing said first flow velocity comprises stopping abruptly.

7. The method of claim 1, wherein the steps of stopping or reducing said first or said second flow velocities comprises stopping or reducing for a period of 5-60 minutes.

8. The method of claim 1, wherein the steps of removing said first or said second upper portion of said liquid comprises removing 50% or more of volume of said liquid.

9. The method of claim 1, further comprising the step of adding an amount of liquid to said liquid prior to providing said second uniform flow velocity.

10. The method of claim 9, wherein said added amount of liquid comprises liquid from said first or said second upper portion, from which algal strains present therein have been removed, killed, or otherwise rendered incapable of reproducing.

11. The method of claim 1, wherein the steps of providing said second uniform flow velocity, stopping or reducing said second uniform flow velocity, and removing said second upper portion of said liquid are repeated about every two or more days.

12. The method of claim 11, wherein the steps of providing said second uniform flow velocity, stopping or reducing said second uniform flow velocity, and removing said second upper portion of said liquid are repeated until 80% or more of solids within the liquid settle within 10 minutes.

13. The method of claim 11, wherein the steps of providing said second uniform flow velocity, stopping or reducing said second uniform flow velocity, and removing said second upper portion of said liquid are repeated over a period of 3-8 weeks.

14. The method of claim 1, further comprising the step of inoculating at least one of said one or more rapidly settling algal strains into said liquid prior to providing said first uniform flow velocity within said container.

15. The method of claim 14, wherein the steps of providing said second uniform flow velocity, stopping or reducing said second uniform flow velocity, and removing said second upper portion of said liquid are repeated over a period of 1-3 weeks.

16. The method of claim 1, further comprising the steps of:
providing a third uniform flow velocity within said first container of said liquid after said algal floc has formed;
stopping or reducing said third uniform flow velocity; and
harvesting said algal floc.

17. The method of claim 16, wherein said third uniform flow velocity is different from said second uniform velocity.

18. The method of claim 17, wherein the step of providing said third uniform flow velocity is implemented for at least one day, and wherein the step of stopping or reducing said third uniform flow velocity comprises stopping or reducing for a period of 5 minutes-6 hours.

19. The method of claim 16, further comprising the step of transferring said liquid into a second container prior to stopping or reducing said third uniform flow velocity.

20. The method of claim 19, wherein the step of harvesting said fast settling algal floc is performed on an essentially continuous basis.
